(19) United States
(12) Patent Application Publication
(10) Pub. No.: US 2016/0143310 A1
(43) Pub. Date: May 26, 2016

(54) FOOD COMPOSITION IN POWDER WITH SWEETENER AND SPARKLING, FREE OF LIPID AND PROTEIN

(71) Applicant: Hypermarcas SA, Sao Paulo (BR)

(72) Inventors: Airton Alves dos Santos, Osasco - SP (BR); Patrícia Paccagnella de Picoli, Sao Paulo (BR); Roberta Domingues Soares da Silva, Carapicuíba - SP (BR); Rosana Gravina, Barueri - SP (BR); Antonio Carlos Vanzo, JR., Santana de Parnaiba - SP (BR)

(73) Assignee: Hypermarcas SA, Sao Paulo (BR)

(21) Appl. No.: 14/582,347

(22) Filed: Dec. 24, 2014

(30) Foreign Application Priority Data
Nov. 20, 2014 (BR) 1020140289674

(51) Int. Cl. A23F 5/40; A23F 5/42

(52) U.S. Cl. CPC A23F 5/40; A23F 5/42

(57) ABSTRACT

The present invention discloses a food composition in soluble coffee powder which comprises a combination of sweetening agents and a foaming agent, substantially free of lipids or proteins. Such a formulation increases the sensory performance of homemade flavored coffee prepared by brewing or filtration. The combination of the sweeteners and foaming agent enhances the body of the coffee and the presence of foam presents improvement of texture in the taste, transforming the filtered or brewed coffee in a coffee similar to the espresso coffee.

### CROSS REFERENCE TO RELATED APPLICATIONS

This application claims the priority benefit of Brazil Patent Application No. 1020140289674, filed Nov. 20, 2014, incorporated herein by reference.

### BRIEF DESCRIPTION OF THE DRAWINGS

FIG. 1 shows a coffee prepared by traditional infusion on filter paper, moments before being sweetened. In this image, it is observed a drink free of foam and dark colored drink.

FIG. 2 shows the same coffee prepared after adding and mixing 1 g of the composition of the present invention.

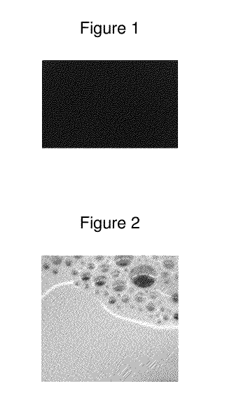

### DETAILED DESCRIPTION

The present invention belongs to the field of human necessities, more specifically to the field of food and refers to a food composition in powder form, presenting at least one sweetening agent and at least one foaming agent, substantially free of lipids and proteins, for beverages. This food composition is used to sweeten hot and cold drinks and especially strained or filtered coffee in homely way, making it with appearance and body similar to the espresso coffee.

The infusion of homemade coffee in Brazil is done in several ways, among them, the drink is strained or filtered. Traditionally, the brewed coffee is usually prepared on strainers of reusable fabric, as the filtrate coffee passes through disposable paper filters that regulate the filtration time through a combination of larger and smaller holes on the paper.

The espresso coffee is prepared in machine through the hot water passage on the high pressure of the ground coffee beans. The pressure may range from 900 to 1000 “Pascal (unit)”. Due to this pressure, the espresso coffee has consistency greater than the brewed coffee, a higher amount of dissolved solids per volume and its measure is generally realized at doses.

A good espresso has three main parts: heart, body and foam that provide a different sensory experience in each coffee. The heart is the layer of the bottom of the cup, deep and strong brown color, contains the bitterness that provides a balance with the sweetness of the aroma of the coffee. The body is the middle layer of espresso, perceived as a sensation in the mouth caused by a persistence on the palate. The body can be mild or intense color between caramel and brown. The foam or cream is the top layer of golden-brown color, containing the finer aromas and flavors of coffee and generally has similar color to dark caramel, which remains on the surface of the drink and comprises vegetable oils, protein and “Sugar”. A creamy, stable and consistent foam is valued by the consumer. The body of the espresso coffee is highly valued and it is a perception of flavor and also a visual perception of consistency and adherence of the liquid to the edges of the cup. A full-bodied coffee adheres more to the walls of the cup, appears to be dense, have good amount of foam in the mouth and expresses markedly its taste. In layman's language, we can also compare the body with the creaminess, more body, more creamy.

The foam is highly valued by the consumer, because it enhances the perception of flavor on the palate of various beverages, such as espresso coffee, juice, hot chocolate, cappuccino, milk shakes, etc. The amount of foam depends on the capacity of incorporation and stabilization of air and formulation gases. In the case of coffee, the foam cannot add new flavor to the drink, only intensify the experience of characteristic taste of the coffee.

Some foaming agents were found in the prior art, as well as substances to stabilize the foam formed.

WO 2006/022540 describes a foaming composition in powder, soluble in cold water which is formed by a mixture of a foam stabilizer and a medium chain triglyceride, whose stabilizer is a water-soluble protein derived from milk or plant. The presence of lipids in this composition makes it impossible to use in coffee as alter the characteristic taste of the drink.

U.S. Pat. No. 7,534,461 describes a foaming composition in soluble powder, comprising carbohydrate particles with pressurized gas in its empty spaces and a free emulsifier proteins. The said emulsifier is selected from a group that consists of a polysorbate, sucrose ester, stearoyl lactylate, mono/digliceride, diacetyl tartaric acid ester of mono/digliceride, phospholipid, propylene glycol alginate, lipophilic modified starch, and its mixtures. Such a composition presents lipids, therefore differs from the composition of the present invention to be presented in the text of this document. Additionally, as said, the presence of lipids in this composition makes it impossible to use in coffee, as it alters the characteristic taste of the drink. Thus, this solution is also not ideal.

The saccharin, cyclamate, aspartame, sucralose, stevia, acesulfame and other sweeteners have different and hard to predict sensory characteristics. It cannot generalize changes in sweetening power as a function of temperature, because it may vary depending on the chemical class of sweetening agent and the dispersion medium wherein the sweetening agent is found.

Develop a new dietary sweetener by mixing sweeteners and obtain a balance of flavor, intensity and aftertaste is not a simple ratio of ingredients. The sweetener performance depends on the variety used and requires sensory balance, synergy analysis for each case and the sweetening power.

To make an espresso coffee, it is necessary to have access to an espresso machine and learn to prepare it. Many environments do not provide such resources.

Thus, in an attempt to provide the consumer, alienated from the access to an espresso machine, but with the intention to enjoy a drink with such features provided by the same, the inventors of the object of the present application sought to develop a solution that could be used immediately to change the brewed coffee, which was easy to use, portable and immediate consumption.

Therefore, one purpose of this invention is to transform the brewed coffee or boiled in a drink with espresso coffee characteristics, even without going through an espresso machine.

A further object of the present invention is to provide a powdered food composition which contains at least one sweetening agent and at least one foaming agent which is substantially free of lipids and proteins.

Another object of the present invention is to provide a powdered food composition containing at least one sweetening agent and at least one foaming agent which changes a filtered brewed coffee or a drink with body characteristics, flavor, and appearance of a creamy coffee espresso.

The present invention presents a powdered food composition with a combination of sweetening agents and foaming agent which creates a rich and consistent foam in traditional coffee prepared by infusion, strained or filtered, making the drink more full-bodied in taste and similar to espresso coffee. That is, mimics in the drink elements not extracted by powder due to low pressure of these preparation methods. The composition presented here does not have lipids, triglycerides, proteins, lactose, monosaccharides or disaccharides. The composition comprises sucralose, acesulfame potassium, silicon dioxide and a gas encapsulated in a matrix of maltodextrin, corn starch and quillaja extract. This matrix with the encapsulated gas is the foaming agent.

The foaming food and beverage depends on the incorporation of air or gas in the composition. Gases like oxygen, nitrogen and carbon dioxide are edible, in this case we chose the latter by giving the best features foam formed in the cafe. By adding the food composition in powder with the sweetening agent and foaming agent to coffee, the gas expands in the carbohydrate matrix forming the foam. After a few seconds, this foam concentrates on the beverage surface, making it more creamy texture, tasty and full-bodied, similar to espresso coffee. The Quillaja extract helps stabilize the foam.

Various sweeteners are used as diet sweeteners such as potassium acesulfame, sucralose, aspartame, neotame, stevia, steviosideos, steviol, isosteviol, monk fruit, sorbitol, isomalt or isomaltitol, lactitol, thaumatin, erythritol, xylitol, mannitol, saccharin, cyclamates and mixtures thereof.

It is challenging to join different sweetening agents to form a dietary sweetener, as the sweetener power can vary according to the chemical class of the said sweetening agent, concentration of each sweetener, the temperature of the environment and also in a dispersion environment in that is found. The acesulfame and sucralose K, in the amounts used in the invention exhibit a combination of sweetness longer than the regular sugar and minimizes the presence of unpleasant aftertaste.

For the development of the present invention, it was considered the fact that people with diseases such as diabetes, obesity and lactose intolerance could use the product, so we opted for ingredients with the lowest possible glycemic index and which does not cause symptoms of intolerance, respectively. Dietary sweeteners are also used by people who eat with caloric restriction, thus we reduced the amount of calories to a minimum. Initially, were tested foaming agents with lactose as a vehicle and glucose as part of its composition. To avoid the increase of the abrupt glycemic index caused by glucose, a formulation was developed with other carbohydrates in the encapsulation of gas: maltodextrin and corn starch.

Referring to the drawings, FIG. 2 shows the foam with a light brown surface with said foam occupying substantially the entire surface of the drink, the more dense in the edges of the cup and less densely in the central region. Not only the color of the drink has changed, but also its texture which is described immediately after the judges in qualitative and quantitative research. The visual differences before and after the addition of the powdered food composition with sweetener and foaming agent are very significant in texture, color and density of the foam presented.

The powder food composition with a sweetening agent and foaming agent was tested in the presence of lipids in the formulation of encapsulated gas matrix, in this case coconut oil. However, lipids give a greasy appearance in the coffee surface in fat globules format. After this finding, the lipids of the compositions are withdrawn.

Two researches with user judges were performed in the category of sweeteners judges and that drink coffee.

Qualitative Research

In order to evaluate the acceptance of judges of coffee sweetened with the composition herein, a qualitative study was carried out through group discussion technique with structured script, with women 25 to 40 years, users of the category of sweeteners and that drink coffee. The results were compiled by qualitative analysis of consumer interpretation.

The coffee was prepared in the proportion of 80 g of coffee powder to 1 liter of water, electric coffee maker in order to standardize the temperature of the water used in infusion. The coffee powder used was standardized in brand, variety of flavor and production batch. Standard paper filters were used and the drink was served hot tasting with up to 30 minutes of preparation. The powder food composition with a sweetening agent and foaming agent was packed in white sachets containing 1 g of powder without the presence of the brand. The tasting occurred with the combined groups.

After the tasting, the judges commented on the experience of taking the coffee sweetened with the present invention. In the subjective perception of judges, we highlight here some placements:

Perception of Sweetness and Aftertaste:

The judges described the taste of coffee sweetened with the composition presented here as similar to coffee sweetened with sugar and no aftertaste. These characteristics were also confirmed in quantitative research commented below.

Perception of Taste:

the presence of foam in contact with the mouth brings a sense of thicker and creamier coffee. Characteristics also confirmed in quantitative research.

Visual Perception:

the judges commented that the composition presented here makes and maintains a full-bodied foam similar to the foam of espresso coffee. This foam is seen on the coffee surface and in the edges of the cup. Some foam characteristics are quantified in the following quantitative research. The appearance of the composition approaches that of a strained/traditional coffee to that of a espresso coffee in the presence of foam.

Conclusions:

Using the composition of the present invention, the coffee was perceived as more full-bodied taste, the sweetness similar to common sugar, with no residual taste and creamier. Also, another perception of the judges on the new composition was to enhance the sensory experience of taking filtered coffee with the appearance and flavor similar to the espresso coffee.

Quantitative Research

The quantitative survey performed was assessment of food composition in powder with a sweetening agent and foaming agent in individual tastings, by sensory analysis technique of food, with evaluation in ideal scale, intensity, hedonic scale, matching question and intention of purchase in quantitative method with 60 judges.

The tasting occurred in individual booths following specific protocol, with temperature, quantity served and standard utensils. The powder food composition with a sweetening agent and foaming agent was packed in white sachets containing 1 g and without the presence of the brand.

The coffee was prepared in the proportion of 80 g of coffee powder to 1 liter of water, in electric coffee maker in order to standardize the temperature of the water used in infusion. The coffee powder used was standardized in brand, variety of flavor and production batch. Standard paper filters were used and the drink was served hot tasting with up to 30 minutes of preparation.

The judges were given 1 sachet containing the powder of food composition in powder with sweetening agent and foaming agent and 50 ml of freshly-prepared and filtered coffee were instructed to add the content of the sachet to coffee, mix and pause for 15 seconds before the beginning of the tasting.

60 judges rated the following features of sweetened coffee powder with the powder food composition with a sweetening agent and a foaming agent:
Ease of dissolution
Acceptance of the foam aspect
Acceptance of the coffee creaminess
Approval of the concept of composition
Ideal sweetness
Bitter residual presence
Ideal creamy foam
Purchase intent

The judges filled out a questionnaire after tasting in the cabin. To evaluate the characteristics above, affective tests and purchase intention were used with the following scales:

Two characteristics were evaluated by method of Sensory Analysis of Food by hedonic rating scale and had the statistical analysis performed by ANOVA—“t” student. The scale used was 7 points to the characteristic of “acceptance foam aspect” with the question: “How much did you like/dislike the visual aspect of the foam formed in your coffee?” The same scale was used for the characteristic of “acceptance of foam aspect” with the question: “How much did you like/dislike the creamy coffee?”. The possible answers were:

1=Disliked a lot

2=Disliked

3=Disliked a little

4=Neither liked nor disliked

5=Liked a little

6=Liked

7=Liked a lot

The characteristic of “sweetness” was evaluated by method of Sensory Analysis of Food through intensity assessment “Just about right” and the statistical analysis performed by the “k Test-proportions.” The scale used was the optimal scale, also 7 points. The question and possible answers to the feature of “sweetening” were: How do you rate the sweetener as to the power of sweetness?

1=Much less sweet than I like

2=Less sweeter than I like

3=A little less sweet than I like

4=The way I like

5=A little sweeter than I like

6=Sweeter than I like

7=Much more sweet than I like

In the same method, the ideal scale was also used for the characteristic of “ideal creaminess” with the question and possible answers: How do you rate the creaminess of the foam?

1=Much less creamy than I like

2=Less creamy than I like

3=A little less creamy than I like

4=The way I like

5=A little more creamy than I like

6=More creamy than I like

7=Much more creamy than I like

The characteristic of “presence of bitter residual” was evaluated by the method of sensory analysis of foods by evaluating intensity and the statistical analysis was performed by ANOVA—“t” student. The scale used was the intensity of 7-point scale, with the following question and possible answers: “How do you evaluate the sweetener sample as the bitter aftertaste that remained in your mouth after eating”?

1=No residual

2=Very weak bitter aftertaste

3=Weak bitter aftertaste

4=Moderate bitter aftertaste

5=Strong bitter aftertaste

6=Very strong bitter aftertaste

7=Extremely strong bitter aftertaste

In the same method, the intensity scale of 7 points was also used for the characteristic of “ease of dissolution” with the following question and possible answers: How do you rate the sweetener at to the ease of dissolution in coffee?

1=Very difficult

2=Difficult

3=A little difficult

4=Neither easy/nor difficult

5=Somewhat easy

6=Easy

7=Very easy

The characteristic of “concept approval of the composition” was performed by the method of sensory analysis of food through the concept of approval and the statistical analysis was performed by z test-proportions. The question of agreement used for the feature “approval concept of the composition” was: “Can this sweetener turn your everyday coffee in a special coffee?”. The response options were:

Yes

No

The characteristic of “intention to purchase” was evaluated by the method of sensory analysis of foods by evaluating attitude, and the statistical analysis was performed by ANOVA—“t” student. Assessment test of intent of purchase: The standardized scale by 5 points which measures the intention of purchase of food composition in powder with a sweetening agent and foaming agent tested with the following question and possible answers was used: “If this product was the sale, which would be its intention to purchase?

1=Certainly would not buy

2=Probably would not buy

3=Do not know whether or not buy

4=Probably would buy

5=Certainly would buy

Results

The level of confidence in the results is 95% and the average grades awarded by the judges were:

| | Average | |
|---|---|---|
| Feature | grade | Description |
| Ease of dissolution | 6.1 | “Easy” |
| Acceptance of the foam aspect | 6.2 | “I liked” |
| Acceptance of the coffee creaminess | 5.7 | “I liked” |
| Approval of the concept of | 87% | Yes |
| composition | | |
| Ideal sweetness | 75% | “The way I like |
| Bitter residual presence | 3.0 | “Weak bitter aftertaste |
| Ideal creamy foam | 75% | “The way I like |
| Intent of purchase | 4.2 | “I would probably buy” |

Considering the “ease of dissolution” of powdered food composition with a sweetening agent and foaming agent in filter coffee, the mean grade of the judges was 6.1 on a scale of 1 (very difficult) to 7 (very easy).

The foam characteristics also had good evaluation. Acceptance of foam aspect had grade of 6.2 on a scale of 1 (dislike very much) and 7 (liked). Another valued feature was the ideal creamy foam that 75% of judges noted the “the way I like it” on the scale from 1 (much less creamy than I like) to 7 (much more creamier than I like).

The ideal sweetness also had a good assessment. 75% of judges noted the “the way I like it” on the scale from 1 (much less sweet than I like) to 7 (much more sweeter than I like). So, ¾ of judges perceive the sweetness at its best expression, in ideal shape, ie, “the way I like it.”

The characteristic of the presence of residual bitter received on average 3.0 in the rating of consumers. The note indicates that the perception is that the bitter residual is weak, in the scale of 1 (no bitter residual) to 7 (extremely strong bitter residual). This grade is below average, which is highly positive in the evaluation of sweeteners.

Considering the coffee creaminess with the food composition in powder with a sweetening agent and foaming agent, the grade average of the judges was 5.7 on a scale of 1 (dislike very much) to 7 (liked much). The coffee creaminess is also associated with body and texture perceived in the mouth.

The concept approval feature of the composition was highly evaluated, 87% of judges chose “Yes” from the options “yes” or “no.” Therefore, almost 9 out of 10 judges believe that powdered food composition with a sweetening agent and foaming agent can indeed turn everyday coffee in a special coffee.

The scale of intention to purchase used was the standardized 5-point scale ranging from 1 (definitely would not buy) to 5 (certainly would buy). The powdered food composition with a sweetening agent and foaming agent had an average score of 4.2 indicating the “probably would buy”.

Quantitative research shows that powdered food composition with a sweetening agent and foaming agent fulfills its role of turning filtered coffee in a similar drink to the espresso coffee with foam characteristics, body, flavor, creaminess, dissolution and approval that would make judges acquiring such a composition or product to incorporate the features of the traditional espresso coffee. So, it was confirmed the perception of flavor, sweetness, aftertaste and visual perception commented by the judges in qualitative research. The combination of sweeteners sucralose and acesulfame k in the proportions cited therein tends to mask the aftertaste of acesulfame K and gives a “weak bitter residual” in the perception of judges, which is highly valued in this invention and other compositions of sweeteners.

The powder food composition with a sweetening agent and foaming agent when formed by sweeteners sucralose and acesulfame potassium comprise sucralose in percentages from 0.1 to 5% and preferably from 0.1 to 2.0%. It also comprises potassium acesulfame potassium in a percentage from 0.1 to 5% and preferably from 0.1 to 2.0%.

One feature of this invention is that the agent is offered foaming agent which enhances the taste and matches the espresso coffee through a balanced mix of sweetness and privileged to have low residual flavor. Both sweetener ingredients such as foaming agent used in the present invention does not have lipids or proteins in the formulation. This Quillaja extract in the following composition acts as the foam stabilizer.

The powdered food composition with a sweetening agent and foaming agent can be used to thicken and enhance the taste experience in other hot drinks such as lattes, cappuccino and tea.

Below a composition of the present invention is presented without, however, restricting the use to this particular example.

### Example 1

### Powdered Food Composition with a Sweetening Agent and Foaming Agent, Substantially Free of Lipids and Proteins

| Ingredient | % in total weight |
|---|---|
| sucralose | 1.19% |
| acesulfame K | 0.51% |
| silicon dioxide | 0.40% |
| encapsulated gas matrix | 97.90% |
| (foaming agent | |
| maltodextrin | from 90 to 95% |
| corn starch | from 3 to 9.5% |
| extract quillaja | from 0.1 to 0.8% |

The encapsulated gas matrix can vary in amounts from 30% to 99% of the total weight of the composition.

To simplify, the process of manufacturing of the above composition is: Weigh the sucralose, acesulfame-K, silicon dioxide, and the gas encapsulated matrix in the amount indicated in the formula. Add all ingredients in blender and blend until to stay smooth.

1. A powdered food composition comprising sucralose and potassium acesulfame as sweetening agents and at least one foaming agent, free of lipids and free of proteins.

2. The powdered food composition according to claim 1, wherein the foaming agent only contains carbohydrates, quillaja extract, and edible gas.

3. The powdered food composition of any one of claim 1 or 2, further comprising at least one of the sweetening agents selected from the group consisting of aspartame, neotame, stevia, stevioside, steviol, isosteviol, monk fruit, sorbitol, isomalt or isomaltitol, lactitol, thaumatin, erythritol, xylitol, mannitol, saccharin, and cyclamates, or combinations thereof.

4. Powdered food composition of any one of claims 1-3 wherein it changes a filtered or brewed coffee in a drink with the body characteristics, flavor, and appearance of an espresso coffee.

5. The powdered food composition of claim 4, which enhances the body of the brewed or filtered coffee, latte, or cappuccino, making it more creamy and full-bodied than the strained or filtered coffee, latte, or traditional cappuccino.

6. The powdered food composition of any one of claims 1-4, which presents, when added to the brewed or filtered coffee, a foam similar to that of espresso coffee.

7. The powdered food composition of claim 1, wherein said composition is able to alter a brewed or filtered coffee in a drink with the body characteristics, flavor, and appearance of an espresso coffee.

8. The powdered food composition of claim 1, wherein said composition provides a low residual bitter taste with substantially grade 3.0 or less in food sensory analysis research, in the evaluation with judges in bitter residual intensity scale ranging from 1 (no aftertaste) to 7 (extremely strong, bitter aftertaste), through a food sensory analysis technique, with evaluation of intensity and statistic confidence of 95%.

9. The powdered food composition of claim 1, comprising sucralose in an amount ranging from 0.1% to 3% by weight of said food composition.

10. The powdered food composition of claim 1, comprising potassium acesulfame in an amount ranging from 0.1% to 2% by weight of said food composition.

11. A process of manufacturing a powdered food composition comprising sucralose, acesulfame K, silicon dioxide, and a gas-encapsulated matrix, comprising the following steps:
adding all the ingredients into a mixer, and
mixing the composition until it stays homogeneous,
wherein the composition comprises
an amount of sucralose ranging from 0.1% to 3% of the total weight of said composition, acesulfame K from 0.1% to 3% of the total weight of said composition,
silicon dioxide ranging from 0.40% of the total weight of said composition,
and the gas-encapsulated matrix in an amount of 80% to 99% of the total weight of the composition.

12-13. (canceled)

14. The powdered food composition of claim 9, comprising sucralose in an amount ranging from 0.1% to 2.0% by weight of said food composition.

15. The powdered food composition of claim 10, comprising potassium acesulfame in an amount ranging from 0.1% to 1.5% by weight of said food composition.
